(19) United States
(12) Patent Application Publication
(10) Pub. No.: US 2018/0189654 A1
(43) Pub. Date: Jul. 5, 2018

(54) DATA PREDICTION DEVICE, DATA PREDICTION METHOD, AND PROGRAM

(71) Applicant: NIPPON TELEGRAPH AND TELEPHONE CORPORATION, Chiyoda-ku (JP)

(72) Inventors: Kazumichi SATO, Musashino-shi (JP); Hiroshi YAMAMOTO, Musashino-shi (JP); Taichi KAWANO, Musashino-shi (JP); Kei TAKESHITA, Musashino-shi (JP)

(73) Assignee: NIPPON TELEGRAPH AND TELEPHONE CORPORATION, Chiyoda-ku (JP)

(21) Appl. No.: 15/735,846

(22) PCT Filed: May 27, 2016
(86) PCT No.: PCT/JP2016/065689

§ 371 Date: Dec. 12, 2017

(30) Foreign Application Priority Data
Jun. 18, 2015 (JP) 2015-123273

(51) Int. Cl. G06N 5/02

(52) U.S. Cl. CPC G06N 5/02

(57) ABSTRACT

A data prediction device includes a predictor configured, among a plurality of data prediction schemes each of which has an application condition and a priority, among the data prediction schemes each of which has the application condition satisfied by a set of past observation data, to use a first data prediction scheme having a highest priority, so as to calculate a predicted value of next observation data, based on the set of the observation data; an accuracy calculator configured, in response to receiving the next observation data as input, to compare the predicted value with the observation data, so as to calculate precision of the first data prediction scheme; and a changer configured to change the priority of the first data prediction scheme, based on the precision calculated by the accuracy calculator; and thereby, enables selection of a scheme that makes the prediction accuracy higher among the data prediction schemes.

### TECHNICAL FIELD

The present invention relates to a data prediction device, a data prediction method, and a program.

### BACKGROUND ART

Various technologies have been proposed as prediction schemes to predict data to be observed next, from data observed in the past. For example, multiple linear regression analysis, which is a multivariate analysis, is a model for describing a variable using the other variables when multiple parameter variables are given, and is used as a data prediction scheme.

Here, consider as an example that a certain user predicts a throughput (the amount of data transferred per unit time) when using a certain Internet service. For the sake of simplicity, assume that the throughput can be estimated (described) from the following three parameters. Also, each of the parameters has five elements as follows:
1. Use time range: T={t1, t2, t3, t4, t5}
2. Use location: L={l1, l2, l3, l4, l5}
3. Use service: S={s1, s2, s3, s4, s5}

Assume here that these information items are stored as illustrated in FIG. 1 every time the user uses the Internet service, to predict the throughput by using the average of combinations having the same elements of T, L, and S. For example, in data observed as in FIG. 1, the predicted value of the throughput at the time range t1, at the location l1, and for the service s1 is calculated as (1000+1100)÷2=1050.

### RELATED ART DOCUMENTS

### Non-Patent Documents

Non-patent document 1: Tatsuya Mori, Kazumichi Sato, Yosuke Takahashi, Tatsuaki Kimura, Keisuke Ishibashi, “Combining the outcomes of IP reputation services”, Technical Committee on Internet architecture of IEICE, 2011
Non-patent document 2: “Deployment of KY method (Binary classification and multiple regression)”, Proceedings of Symposium of Japanese Society of Computational Statistics (26), 9-12-2012-11-01, Japanese Society of Computational Statistics

### SUMMARY OF INVENTION

### Problem to be Solved by the Invention

However, all combinations of information items of the time range, location and service may become extremely large, and it may be difficult to cover all the cases. In other words, a problem exists in that the number of samples of past observation data may be insufficient for data prediction. For example, in the data observed as illustrated in FIG. 1, no data exists for the time range t1, the location l3, and the service s1, and hence, it is difficult to predict the throughput for this case.

In order to solve this problem, one may intuitively consider using multiple prediction schemes in which the granularity of use parameters is changed. For example, in the case of the above three parameters, one may consider a prediction scheme using all of {T, L, S}, prediction schemes using pairs of two different parameters {T, L}, {T, S}, and {L, S}, and prediction schemes using just one parameter {T} and {L}. Changing the granularity of the parameters to be used in this way increases the number of sample data usable for prediction, and enables prediction. However, there is a problem that if the number of use parameters is reduced, prediction accuracy may become lower. For example, in FIG. 1, if considering a prediction scheme that takes only the location L into account, the throughput observed at the location l5 is 5000 or 500, and such a larger variation may result in a predicted value that is deviated greatly.

Note that Non-patent document 1, which relates to an IP reputation technology for spam determination of e-mail, describes a technology to increase SPAM determination accuracy by taking classification precision of multiple IP reputation databases into consideration at the same time. However, the present invention is a technology aiming at determining application priorities of multiple schemes, and is a technology different from the one in Non-patent document 1 that takes precision of the respective schemes into consideration at the same time.

Also, Non-patent document 2 describes a technology that, for given multiple input parameters, obtains a combination of parameters input into a regression equation such that the prediction accuracy becomes the highest. However, the present invention is a technology that obtains application order of regression equations to be applied to data, based on past prediction accuracy, which is different from the technology described in Non-patent document 2.

The present invention has been made in view of the above, by which it is possible to select a scheme that makes prediction accuracy higher among multiple data prediction schemes.

### Means for Solving the Problem

Therefore, in order to solve the above problem, a data prediction device includes a predictor configured, among a plurality of data prediction schemes each of which has an application condition and a priority, among the data prediction schemes each of which has the application condition satisfied by a set of past observation data, to use a first data prediction scheme having a highest priority, so as to calculate a predicted value of next observation data, based on the set of the observation data; an accuracy calculator configured, in response to receiving the next observation data as input, to compare the predicted value with the observation data, so as to calculate precision of the first data prediction scheme; and a changer configured to change the priority of the first data prediction scheme, based on the precision calculated by the accuracy calculator.

### Advantage of the Invention

It is possible to select a scheme that makes prediction accuracy higher among multiple data prediction schemes.

### BRIEF DESCRIPTION OF DRAWINGS

FIG. 1 is a diagram illustrating an example of data observed in the past;

FIG. 2 is a diagram illustrating an example of a hardware configuration of a data prediction device in an embodiment of the present invention;

FIG. 3 is a diagram illustrating an example of a functional configuration of a data prediction device in an embodiment of the present invention;

FIG. 4 is a flowchart illustrating an example of processing steps executed by a prediction function information generator;

FIG. 5 is a flowchart illustrating an example of processing steps executed by a data predictor;

FIG. 6 is a flowchart illustrating an example of processing steps executed by a prediction accuracy updater; and

FIG. 7 is a flowchart illustrating an example of processing steps executed by a prediction function information series rebuilder.

### EMBODIMENTS OF THE INVENTION

In the following, embodiments will be described with reference to the drawings. FIG. 2 is a diagram illustrating an example of a hardware configuration of a data prediction device in an embodiment of the present invention. The data prediction device 10 in FIG. 2 includes a drive unit 100, an auxiliary storage unit 102, a memory unit 103, a CPU 104, and an interface unit 105, which are mutually connected by a bus B.

A program that implements processing on the data prediction device 10 is provided with a recording medium 101 such as a CD-ROM. When the recording medium 101 storing the program is set in the drive unit 100, the program is installed into the auxiliary storage unit 102 from the recording medium 101 via the drive unit 100. However, installation of the program is not necessarily executed from the recording medium 101, and may also be downloaded from another computer via the network. The auxiliary storage unit 102 stores the installed program, and stores required files, data, and the like as well.

Upon receiving a command to activate the program, the memory unit 103 reads the program from the auxiliary storage unit 102, to load the program. The CPU 104 executes a function which relates to the data prediction device 10 according to the program stored in the memory unit 103. The interface unit 105 is used as an interface for connecting with the network.

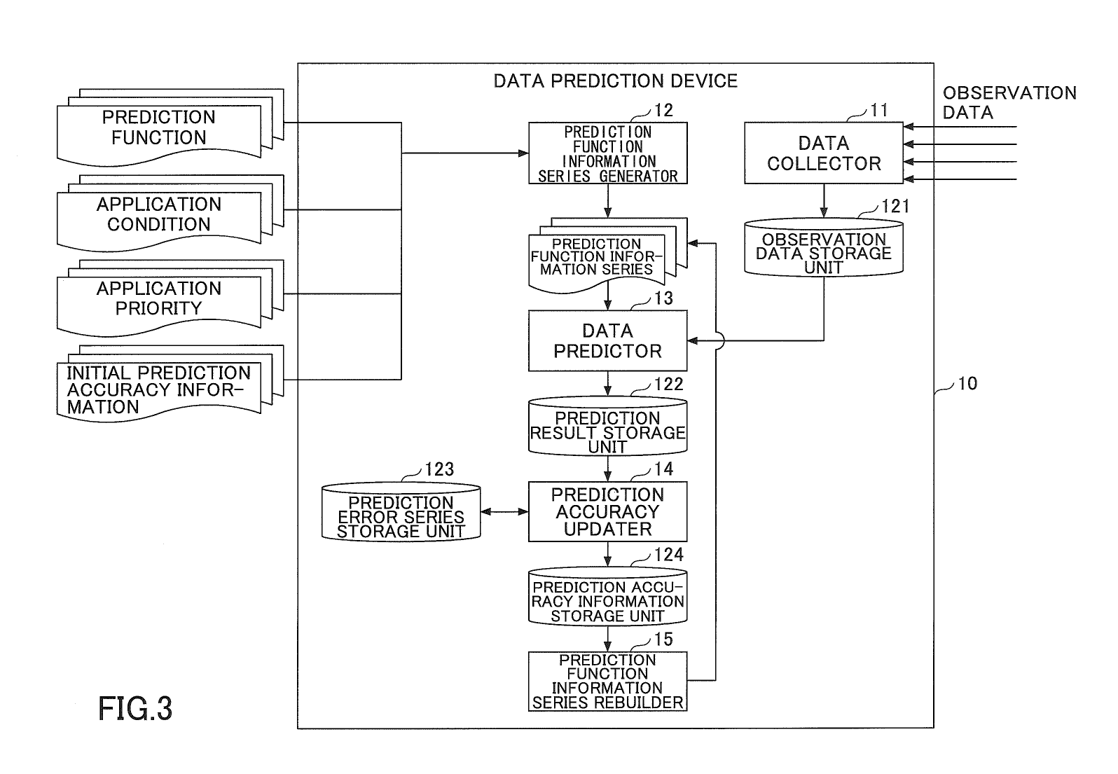

FIG. 3 is a diagram illustrating an example of a functional configuration of the data prediction device in an embodiment of the present invention. In FIG. 3, the data prediction device 10 includes a data collector 11, a prediction function information series generator 12, a data predictor 13, a prediction accuracy updater 14, and a prediction function information series rebuilder 15. These units are implemented by processes that one or more programs installed in the data prediction device 10 cause the CPU 104 to execute. The data prediction device 10 also uses an observation data storage unit 121, a prediction result storage unit 122, a prediction error series storage unit 123, and a prediction accuracy information storage unit 124. The observation data storage unit 121, the prediction result storage unit 122, the prediction error series storage unit 123, and the prediction accuracy information storage unit 124 can be implemented by using, for example, the auxiliary storage unit 102 in FIG. 2 or a memory unit that can be connected to the data prediction device via the network.

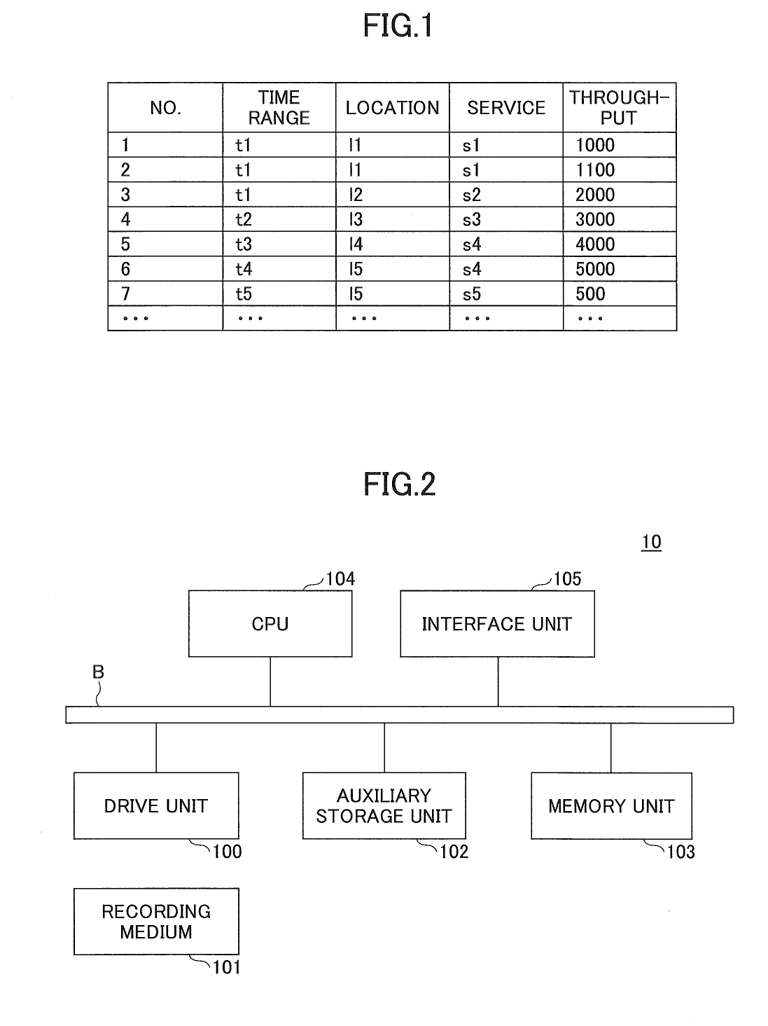

The data collector 11 collects observation data required for data prediction, and stores the collected observation data in the observation data storage unit 121. The observation data storage unit 121 stores, for example, a set of observation data as illustrated in FIG. 1. Note that the observation data is data including observation conditions and observed values. The observation conditions mean conditions, a situation, and the like where an observation object was observed. In FIG. 1, the time range, location, and service correspond to the observation conditions. The observed value means a value observed with respect to an object to be observed. In FIG. 1, the throughput corresponds to the observed value.

The prediction function information series generator 12 takes as input a set of prediction functions (referred to as a “prediction function set”), application conditions of the respective prediction functions, application priorities of the respective prediction functions, and initial prediction accuracy of the respective prediction functions, to generate prediction function information series, which is an array of prediction function information. The prediction function information series generator 12 outputs the generated prediction function information series to the data predictor 13. Note that one item of the prediction function information is information including the application condition, the application priority, and the prediction accuracy of one prediction function.

The data predictor 13 takes as input the prediction function information series output from the prediction function information series generator 12, and the set of the observation data stored in the observation data storage unit 121, to execute data prediction using one of the prediction functions in the prediction function set, and to store a prediction result in the prediction result storage unit 122.

The prediction accuracy updater 14 compares a prediction result stored in the prediction result storage unit 122 with observation data that has been actually observed and corresponds to the prediction result, to calculate the prediction accuracy of the prediction function used for the data prediction. The prediction accuracy updater 14 associates the calculated prediction accuracy with the prediction function used for the data prediction, and stores the associated accuracy in the prediction accuracy information storage unit 124. Also, the prediction accuracy updater 14 outputs the prediction function information series to the prediction function information series rebuilder 15.

The prediction function information series rebuilder 15 takes as input the prediction function information series output from the prediction accuracy updater 14, and the prediction accuracy stored in the prediction accuracy information storage unit 124, to sort and reconstruct the prediction function information series.

Note that the units illustrated in FIG. 2 may be implemented on a single computer, or may be distributed and implemented on multiple computers.

In the following, processing steps executed by the data prediction device 10 will be separately described for Step 1 to Step 4.

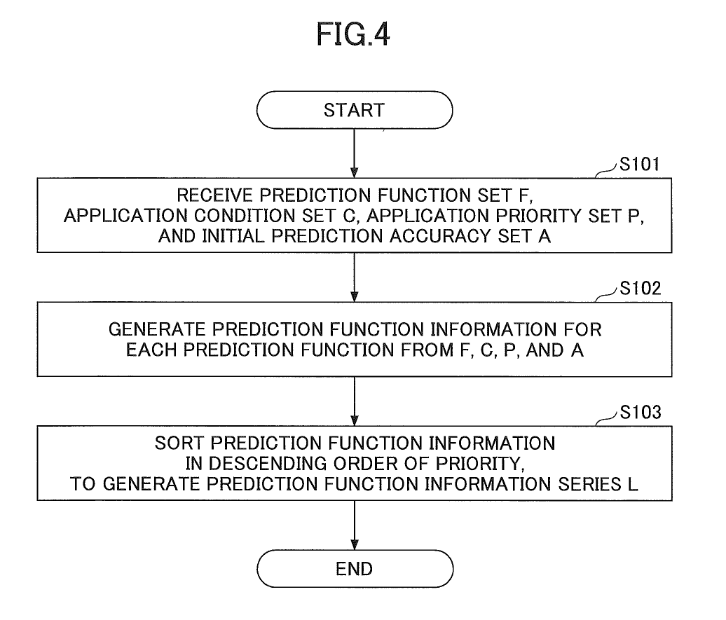

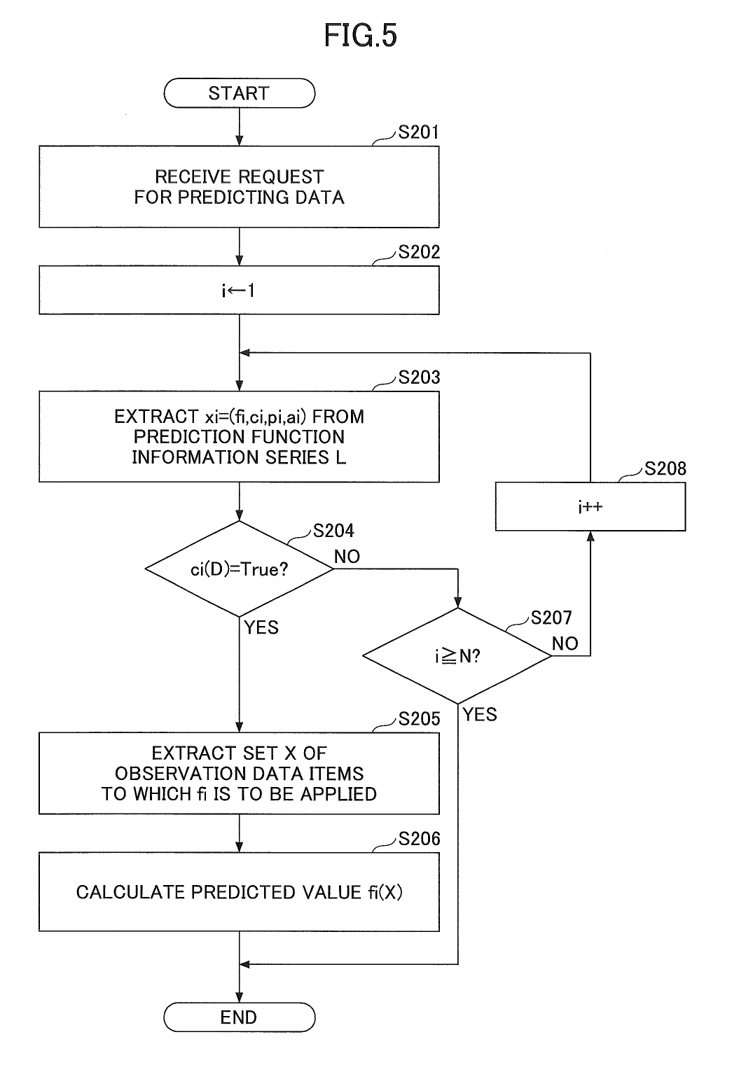

First, Step 1 will be described in detail. Step 1 is executed by the prediction function information series generator 12. FIG. 4 is a flowchart illustrating an example of processing steps executed by the prediction function information series generator.

At Step S101, the prediction function information series generator 12 receives as input a prediction function set F, an application condition set C being a set of the application conditions of the respective prediction functions, an application priority set P being a set of the application priorities of the respective prediction functions, and the initial prediction accuracy set A being a set of the initial prediction accuracy of the respective prediction functions. The prediction function set F includes multiple prediction functions that are different from each other in terms of the granularity or the range (unifiedly referred to as the “granularity”, below) of observation data to be applied. Here, the “granularity of observation data” means the granularity of commonality of observation conditions required by a prediction function for observation data to be applied. The “commonality of observation conditions required by a prediction function for observation conditions” includes, in the example in FIG. 1, the time range being common, the location being common, the time range and location being common, the time range and service being common, the location and service being common, and the time range, location, and service being common. In other words, for a prediction function that executes data prediction based on a set of observation data having a common time range, the time range being common corresponds to the commonality required by the prediction function. Also, for a prediction function that executes data prediction based on a set of observation data having common time range, location, and service, the time range, location, and service being common correspond to the commonality required by the prediction function. In this way, the granularity is specified by a combination of values with respect to items for which the commonality is required, among the items that constitute observation conditions. A set of observation data that satisfies a commonality having a relatively smaller granularity (for example, a set of observation data having the time range, location, and service being common) turns out to be a subset of a set of observation data that satisfies a commonality having a relatively greater granularity (for example, a set of observation data having the time range being common).

Also, the application condition is information representing, for example, a lower limit of the number of observation data items that satisfy a commonality of the observation conditions required by a prediction function, for the items to which the prediction function is applied, in a set of observation data items. The application condition of a prediction function having a commonality of the time being common is, for example, a lower limit of the number of observation data items having a common time.

Also, the application priority is a numerical value that represents a priority (priority order) used for prediction, which is defined in the present embodiment that the smaller the value is, the higher the priority is. Alternatively, it may be defined that the greater the value is, the higher the priority is. The initial prediction accuracy of each prediction function may be set to any appropriate numerical value.

Next, the prediction function information series generator 12 generates the following prediction function information x for each prediction function from the prediction function set F, the application condition set C, the application priority set P, and the initial prediction accuracy set A (Step S102). Here, the size of each set is defined to be N.

xᵢ=(fᵢ, cᵢ, pᵢ, aᵢ)

where fᵢ∈F, cᵢ∈C, pᵢ∈P, aᵢ∈A, and 1≤i≤N.

Next, the prediction function information series generator 12 sorts the prediction function information x in descending order of the application priorities c, to generate prediction function information series L (Step S103). Defining that a smaller subscript has a higher priority, the prediction function information series L is obtained as follows:

L=[x₁, x₂, . . . , x_{N}]

Next, Step 2 will be described in detail. Step 2 is a process that is executed by the data predictor 13 in response to input of a data prediction request, to calculate a predicted value relating to an observation value of next observation data, from data D being a set of past observation data stored in the observation data storage unit 121. The “next observation data” means observation data that is predicted to be observed next.

FIG. 5 is a flowchart illustrating an example of processing steps executed by the data predictor.

At Step S201, the data predictor 13 receives a data prediction request as input. Upon the prediction request, prediction conditions are input. The “prediction conditions” are a set of values corresponding to items that constitute observation conditions. For example, in the example in FIG. 1, time range=t1, location=l1, and service=s1 are input as the prediction conditions. This case corresponds to a prediction request of an observation value (throughput) of observation data having the time range being t1, the location being l1, and the service being s1.

Next, the data predictor 13 substitutes 1 for a variable i (Step S202). The variable i is a variable for identifying an item of prediction function information x to be processed among the prediction function information x included in the prediction function information series L.

Next, the data predictor 13 extracts an item of prediction function information xᵢ=(fᵢ, cᵢ, pᵢ, aᵢ), which is the i-th item of the prediction function information x from the prediction function information series L (Step S203).

Next, the data predictor 13 applies the application condition cᵢ to the data D, to determine whether the data D satisfies the application condition cᵢ (Step S204). If the application condition cᵢ is “the number of observation data items having common time range and location being 100 or more”, and reservation conditions are “time range=t1, location=l1, and service=s1”, then, for example, observation data whose time range is t1 and whose location is l1 is extracted from the data D, to be determined whether the extracted number of observation data items is 100 or more.

If the data D satisfies the application condition cᵢ (YES at Step S204), the data predictor 13 extracts data X as a set of observation data to which the prediction function fᵢ is to be applied, from the data D (Step S205). For example, if the application condition cᵢ is “the number of observation data items having common time range and location being 100 or more”, and reservation conditions are “time range=t1, location=l1, and service=s1”, then, observation data whose time range is t1 and whose location is l1 is extracted as the data X.

Next, the data predictor 13 inputs the data X into the prediction function fᵢ to calculate a predicted value fᵢ(X) (Step S206). For example, the prediction function fᵢ may be a function that calculates an average of the throughput of the data X. The data predictor 13 associates the predicted value fᵢ(X) with the prediction function fᵢ and the prediction conditions, and stores the associated value in the prediction result storage unit 122.

On the other hand, if the data D does not satisfy the application condition cᵢ (NO at Step S204), the data predictor 13 determines whether the value of the variable i is greater than equal to N (Step S207). If the value of the variable i is less than N (NO at Step S207), the data predictor 13 adds 1 to the variable i (Step S208), and repeats Steps S203 and after. If the value of the variable i is greater than equal to N (YES at Step S207), the data predictor 13 ends the process.

According to the process in FIG. 5, if sufficient data has not been accumulated for a prediction function that executes a prediction, for example, with values of three items, a prediction function that executes a prediction with values of two items or one is used, to execute data prediction.

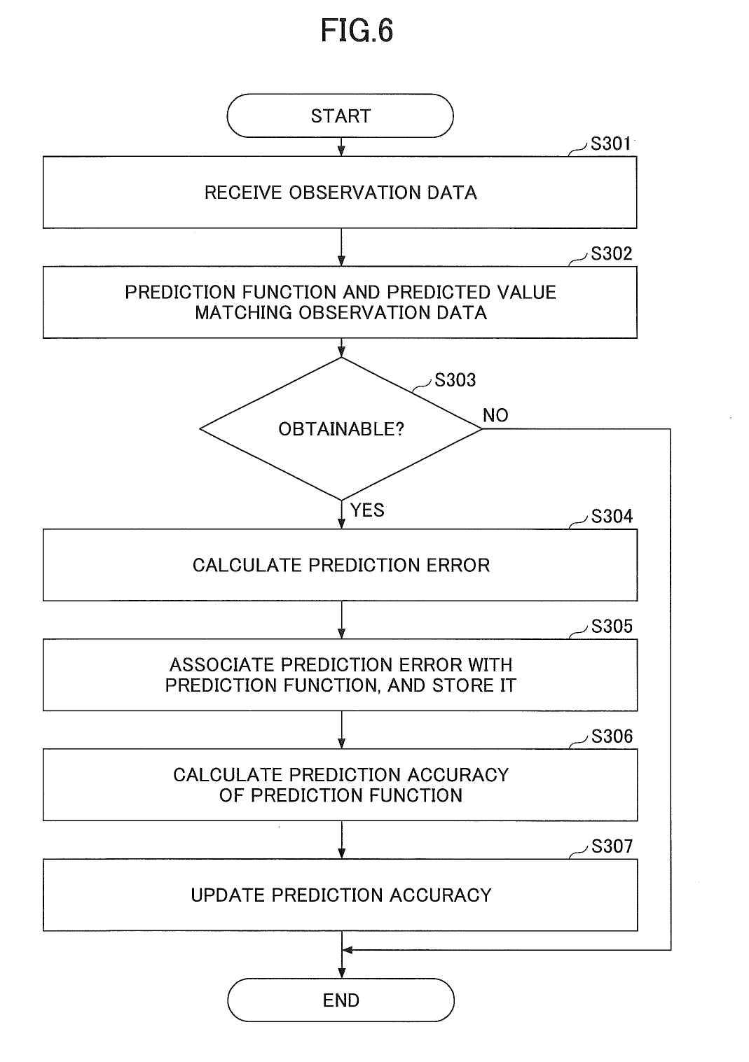

Next, Step 3 will be described in detail. Step 3 is a process that is executed by the prediction accuracy updater 14 to calculate and update prediction accuracy of a prediction function used for data prediction. FIG. 6 is a flowchart illustrating an example of processing steps executed by the prediction accuracy updater.

At Step S301, the prediction accuracy updater 14 receives actually observed data d as input. Inputting the data d may be executed by the user, or may be observed automatically. According to the example in FIG. 1, the data d includes respective values of time range, location, service, and throughput.

Next, the prediction accuracy updater 14 obtains a prediction function f and a predicted value f(X) associated with the prediction conditions matching the data d, from the prediction result storage unit 122 (Step S302).

If a corresponding prediction function f and a predicted value f cannot be obtained (NO at Step S303), the process in FIG. 6 ends. If a corresponding prediction function f and a predicted value f(X) have been obtained (YES at Step S303), the prediction accuracy updater 14 calculates a prediction error error_{f} of the prediction function f as follows:

error_{f}=|f(X)−d|

In other words, the prediction error error_{f} is the difference between the predicted value f(X) and the observation data d. According to the example in FIG. 1, the prediction error error_{f} is the difference between the predicted throughput and the observed throughput.

Next, the prediction accuracy updater 14 associates the calculated prediction error error_{f} with the prediction function f, and stores it in the prediction error series storage unit 123 (Step S305). Therefore, the prediction error series storage unit 123 stores prediction error series LD being an array of prediction errors (history of the prediction error) for each prediction function used for data prediction. Note that the prediction error series LD_{f} of the prediction function f is as follows:

LD_{f}=|error1_{f}, error2_{f}, . . . , errorM_{f}|

Next, the prediction accuracy updater 14 calculates the prediction accuracy of the prediction function f, based on the prediction error series LD_{f} stored in the prediction error series storage unit 123 for the prediction function f (Step S306). Denoting the prediction accuracy of the prediction function f by a, a is calculated, for example, as follows:

a=(ΣLD_{f})/|LD_{f}|

where |LD_{f}| represents the number of prediction errors included in the prediction error series LD_{f}.

Next, the prediction accuracy updater 14 updates the prediction accuracy that has been associated and stored with the prediction function f in the prediction accuracy information storage unit 124, by the prediction accuracy a calculated at Step S306.

In this way, the prediction accuracy is updated every time data prediction is executed. Note that another indicator (geometric mean or the like) other than the above may be used as the prediction accuracy.

Next, Step 4 will be described in detail. Step 4 is a process that is executed by the prediction function information series rebuilder 15, to sort the prediction function information series based on the prediction accuracy and default application priorities of the respective prediction functions, and to reconstruct the application priorities of the prediction functions. Note that Step 4 may be executed periodically, or may be executed every time the prediction accuracy of one of the prediction functions is updated at Step 3.

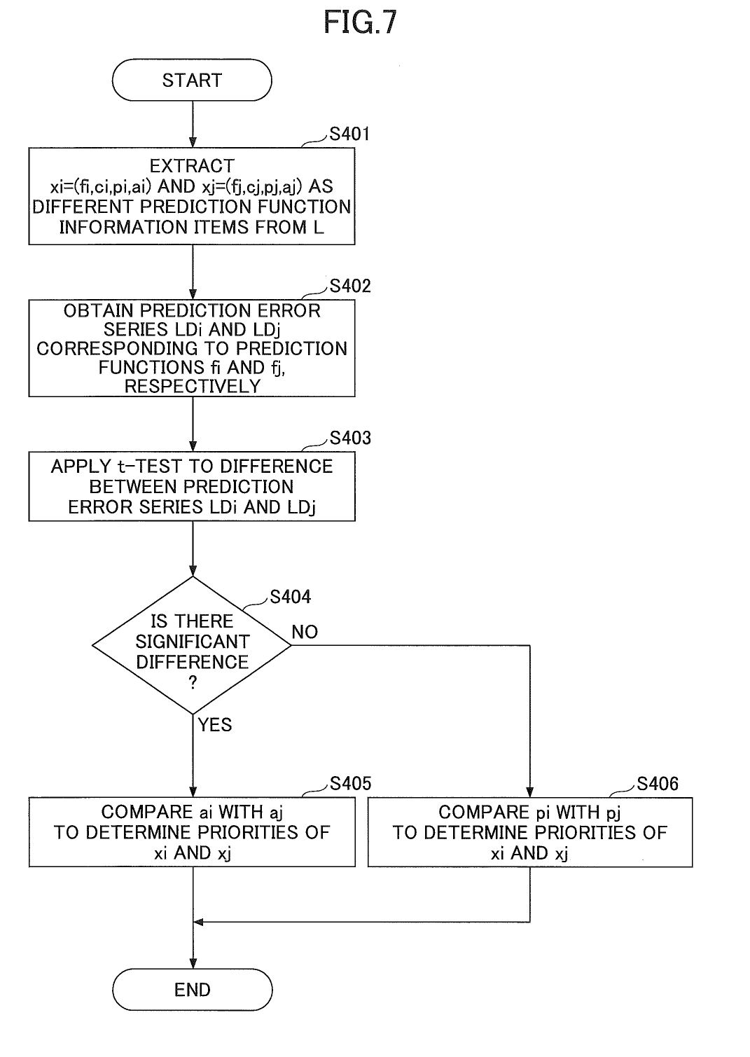

FIG. 7 is a flowchart illustrating an example of processing steps executed by the prediction function information series rebuilder. With FIG. 7, sorting will be described in terms of two elements xᵢ and xⱼ that are included in the prediction function information series L, and are different from each other.

At Step S401, the prediction function information series rebuilder 15 extracts two items of prediction function information xᵢ=(fᵢ, cᵢ, pᵢ, aᵢ) and prediction function information xⱼ=(fⱼ, cⱼ, pⱼ, aⱼ) that are different from each other, from the prediction function information series L. Note that as the prediction accuracy aᵢ and the prediction accuracy aⱼ, values that have been stored in the prediction accuracy information storage unit 124 with respect to the prediction function fᵢ and the prediction function fᵢ, respectively, are used.

Next, the prediction function information series rebuilder 15 obtains the prediction error series LDᵢ corresponding to the prediction function fᵢ, and the prediction error series LDⱼ corresponding to prediction function fⱼ, from the prediction error series storage unit 123 (Step S402).

Next, in order to determine whether the difference between the prediction error series LDᵢ and the prediction error series LDⱼ is statistically significant, the prediction function information series rebuilder 15 executes a t-test (Step S403). In other words, if the prediction application count is small, there is a possibility that the difference aᵢ−aⱼ of the prediction accuracy calculated at Step S405, which will be described later, is not statistically significant. Thereupon, the t-test is executed at Step S403. However, the test method is not limited to the t-test, and another method, such as a nonparametric test, may be used.

If a significant difference has been recognized as a result of the t-test (YES at Step S404), the prediction function information series rebuilder 15 compares the prediction accuracy aᵢ and aⱼ, to determine the priorities of the prediction function information xᵢ and xⱼ (Step S405). Specifically, if aᵢ−aⱼ has been calculated and the calculation result is negative, the prediction function information xi is determined to have a priority higher than that of the prediction function information xⱼ. On the other hand, if the calculation result is positive, xⱼ is determined to have a priority higher than xᵢ. Also, if the calculation result is 0 (if aᵢ=aⱼ), the priority is determined based on default application priorities pᵢ and pⱼ.

On the other hand, if a significant difference has not been recognized as a result of the t-test (NO at Step S404), the prediction function information series rebuilder 15 compares the default application priorities pᵢ and pⱼ, to determine the priorities of the prediction function information xᵢ and xⱼ (Step S406).

By using the comparison step of different elements as described above, the prediction function information series rebuilder 15 sorts and updates the prediction function information series L. Any method of sorting may be adopted, including quick sort and merge sort.

As described above, according to the present embodiment, in a scheme to predict next observation data from past observation data, among multiple prediction functions, based on the priorities and prediction accuracy of the respective prediction functions, an appropriate data prediction function is selected to execute data prediction based on the selected prediction function. Accordingly, even if sample data is insufficient for a certain prediction function when making a prediction, it is possible to execute data prediction by using another prediction function as long as sample data for the other prediction function is sufficient enough. Also, since a prediction function having a higher precision is prioritized to be used, it is possible to raise the precision of data prediction. Also, since the priority is dynamically determined based on a result of data prediction, it is possible to reduce analysis operations of a person who performs data analysis (an operator or the like).

Note that in the present embodiment, the data predictor 13 is an example of a predictor. The prediction accuracy updater 14 is an example of an accuracy calculator. The prediction accuracy updater 14 is an example of a changer. The prediction function is an example of a data prediction scheme.

As above, the embodiments of the present invention have been described in detail. Note that the present invention is not limited to such specific embodiments, but various variations and modifications may be made within the scope of the subject matters of the present invention described in the claims.

The present patent application claims priority based on Japanese Patent Application No. 2015-123273 filed on Jun. 18, 2015, and entire contents of the Japanese Patent Application are incorporated herein by reference.

### LIST OF REFERENCE SYMBOLS

10 data prediction device
11 data collector
12 prediction function information series generator
13 data predictor
14 prediction accuracy updater
15 prediction function information series rebuilder
100 drive unit
101 recording medium
102 auxiliary storage unit
103 memory unit
104 CPU
105 interface unit
121 observation data storage unit
122 prediction result storage unit
123 prediction error series storage unit
124 prediction accuracy information storage unit
B Bus

1. A data prediction device, comprising:
a predictor configured, among a plurality of data prediction schemes each of which has an application condition and a priority, among the data prediction schemes each of which has the application condition satisfied by a set of past observation data, to use a first data prediction scheme having a highest priority, so as to calculate a predicted value of next observation data, based on the set of the observation data;
an accuracy calculator configured, in response to receiving the next observation data as input, to compare the predicted value with the observation data, so as to calculate precision of the first data prediction scheme; and
a changer configured to change the priority of the first data prediction scheme, based on the precision calculated by the accuracy calculator.

2. The data prediction device as claimed in claim 1, wherein every time the predicted value is calculated by the predictor using the first data prediction scheme, the accuracy calculator calculates a difference between the predicted value and the next observation data corresponding to the predicted value, and based on a history of the difference calculated with respect to the first data prediction scheme, calculates the precision.

3. The data prediction device as claimed in claim 1, wherein the predictor, among the set of the past observation data, applies the first data prediction scheme to a set of the observation data that satisfies a commonality required for an application item to which the first data prediction scheme is applied, to calculate the predicted value,
wherein the data prediction schemes are different from each other in terms of granularity of the commonality required for the application item.

4. A data prediction method executed by a computer, the method comprising:
a prediction step for, among a plurality of data prediction schemes each of which has an application condition and a priority, among the data prediction schemes each of which has the application condition satisfied by a set of past observation data, using a first data prediction scheme having a highest priority, so as to calculate a predicted value of next observation data, based on the set of the observation data;
an accuracy calculation step for, in response to receiving the next observation data as input, comparing the predicted value with the observation data, so as to calculate precision of the first data prediction scheme; and
a change step for changing the priority of the first data prediction scheme, based on the precision calculated by the calculation step.

5. The data prediction method as claimed in claim 4, wherein every time the predicted value is calculated by the prediction step using the first data prediction scheme, the accuracy calculation step calculates a difference between the predicted value and the next observation data corresponding to the predicted value, and based on a history of the difference calculated with respect to the first data prediction scheme, calculates the precision.

6. The data prediction method as claimed in claim 4, wherein the prediction step, among the set of the past observation data, applies the first data prediction scheme to a set of the observation data that satisfies a commonality required for an application item to which the first data prediction scheme is applied, to calculate the predicted value,
wherein the data prediction schemes are different from each other in terms of granularity of the commonality required for the application item.

7. A non-transitory computer readable recording medium including a program stored therein for causing a computer to function as the functional units in the data prediction device as claimed in any one of claim 1 to 3 or 8.

8. The data prediction device as claimed in claim 2, wherein the predictor, among the set of the past observation data, applies the first data prediction scheme to a set of the observation data that satisfies a commonality required for an application item to which the first data prediction scheme is applied, to calculate the predicted value,
wherein the data prediction schemes are different from each other in terms of granularity of the commonality required for the application item.

9. The data prediction method as claimed in claim 5, wherein the prediction step, among the set of the past observation data, applies the first data prediction scheme to a set of the observation data that satisfies a commonality required for an application item to which the first data prediction scheme is applied, to calculate the predicted value,
wherein the data prediction schemes are different from each other in terms of granularity of the commonality required for the application item.
